(19) United States
(12) Patent Application Publication
(10) Pub. No.: US 2005/0020234 A1
(43) Pub. Date: Jan. 27, 2005

(54) Data transmission method to a wireless device which does not have an active data connection to a network

(76) Inventors: Juha Iivari, Oulu (FI); Lauri Piikivi, Oulu (FI)

Correspondence Address: Crawford Maunu, Suite 390, 1270 Northland Drive, St Paul, MN, 55120, US

(21) Appl. No.: 10/494,976

(22) PCT Filed: Nov. 7, 2002
(86) PCT No.: PCT/FI02/00871

(30) Foreign Application Priority Data
Nov. 9, 2001 (FI) 20012179

(51) Int. Cl. H04M 11/00

(52) U.S. Cl. 455/403; 455/466

(57) ABSTRACT

The invention relates to a data transmission method between a first device (208) and a second device (100, 102), which is at the end of a wireless network connection and does not have an active data transmission connection to a network. The method comprises the steps of transmitting data addressed to the second device from the first device to the network; detecting in the network that the second device (100, 102) does not have an active data transmission connection; sending a stimulus message from the network to the second device (100, 102); receiving the stimulus message at the second device (100, 102); setting up a data connection between the network and the second device (100, 102) on the basis of the stimulus message; and transmitting to the second device (100, 102) the data addressed to it.

### FIELD OF THE INVENTION

The invention relates to a data transmission method and system in which data is transmitted from one device to another, at least one of the devices being at the end of a wireless connection.

### BACKGROUND

Today telephone systems are used for implementing also various other services than just conventional calls and new service concepts are being continuously designed. Mobile communications systems in particular offer a host of different services. These systems include the GSM and, in particular, the packet-switched GPRS system. The services are popular among the users because most users always carry their mobile phones and thus the services are also always available. Mobile phones can be used to access different Internet services that are used either directly from the phone, or from terminal equipment connected to the phone.

An Internet connection is usually set up by a mobile phone opening an access connection to an Internet service, after which data can be transmitted in both directions. A server connected to the Internet network is able to communicate with the mobile phone or terminal equipment connected to the network and thus having an IP address on the basis of which it can be identified and to which the data transmission can be directed. If the terminal equipment or mobile phone is not connected to the network and does not have an open data connection, it cannot be contacted in current systems. The GPRS specifications determine a connection opening sequence that allows a terminal device to be activated from the network, but none of the system suppliers have implemented the method in their networks due to the security risks involved. With regard to both billing and data security, it is essential that the opening of a connection be only allowed between reliable parties. In addition, the method requires that the GPRS device have a fixed IP address, which the devices in current systems do not have at all, and, moreover, that a GPRS attach has been completed.

Another type of known solution involves push messages implemented using the WAP technology (Wireless Application Protocol). In this solution the user is required to register into the desired server and, in addition, transmitted push messages are not activated at the terminal equipment until the push application, such as a WAP browser, associated with the message has been activated.

### BRIEF DESCRIPTION OF THE INVENTION

It is an object of the invention to provide a method and arrangement in which data can be reliably transmitted between two separate devices even when one of the devices is at the end of a wireless connection. This is achieved by a data transmission method between a first device and a second device, which is at the end of a wireless network connection and does not have an active data transmission connection to a network, in which method data addressed to the second device is transmitted from the first device to the network. The method of the invention further comprises the steps of detecting in the network that the second device does not have an active data connection; sending a stimulus message from the network to the second device; receiving the stimulus message at the second device; setting up a data connection between the network and the second device on the basis of the stimulus message; transmitting to the second device the data addressed to it.

The invention also relates to a data transmission system comprising devices which are at the end of a wireless connection and does not have a continuous, active data transmission connection to a network, and a first device which is arranged to transmit data to a second device, which is at the end of the wireless connection. The system of the invention comprises means for detecting that the second device does not have an active data connection at the moment the system has data addressed to the second device; means for sending a stimulus message to the device; and that the second device comprises means for detecting a received stimulus message and for initiating the setting up of a data connection between the device and the rest of the system on the basis of the stimulus message.

The invention further relates to a terminal device in a data transmission system, which terminal device is at the end of a wireless connection and does not have a continuous, active data connection to the network. The terminal device of the invention comprises means for detecting and receiving a stimulus message sent to it; and means for initiating the setting up of an active data connection between the device and the rest of the system on the basis of the stimulus message.

Preferred embodiments of the invention are disclosed in the dependent claims.

The preferred embodiments thus allow a data connection to be set up also to a terminal device that does not have an active data connection. The data connection to the second device is set up without the first device that is transmitting the data being aware of the waking up of the connection. The first device may only experience a slight delay during the transmission of the stimulus message and the setting up of the data connection.

The method and system of the invention provide several advantages. In a preferred embodiment of the invention the stimulus is given using a different service or channel than the one that is to be woken up. This ensures versatile, flexible, safe and economical stimulus functionalities for the system. Moreover, the solution does not require a separate message for acknowledging the stimulus message, which saves costs. In solutions according to the preferred embodiments, the terminal device responds to a received stimulus message by activating the desired service or channel, possibly transmitting some data on the opened connection to provide a reliable confirmation of the successful accomplishment of the stimulus functionality.

Some preferred embodiments allow different authentications to be made for confirming that the stimulus message originates from an accepted source, allowing at the same time reliable identification of the terminal device.

There are various ways of implementing the stimulus message, such as a Short Message Service (SMS), data call, fax call, Unstructured Supplementary Service Data (USSD) message, Short Message Service Cell Broadcast (SMSCB), or an ordinary call.

The connection established with the stimulus message may be a data call or a GPRS connection, for example.

### LIST OF THE DRAWINGS

In the following, the invention will be described in greater detail with reference to the preferred embodiments and the accompanying drawings, in which

FIG. 1 shows an example of a data transmission system;

FIG. 2 illustrates the activation of a connection involving a terminal device;

FIG. 3 illustrates a method according to an embodiment;

FIG. 4 illustrates different ways of sending a stimulus message to a terminal device;

FIG. 5 illustrates method steps according to a preferred embodiment of the invention;

FIG. 6 illustrates a preferred embodiment of the invention;

FIG. 7 illustrates a second preferred embodiment of the invention; and

FIG. 8 illustrates an example of a terminal device.

### DESCRIPTION OF THE EMBODIMENTS

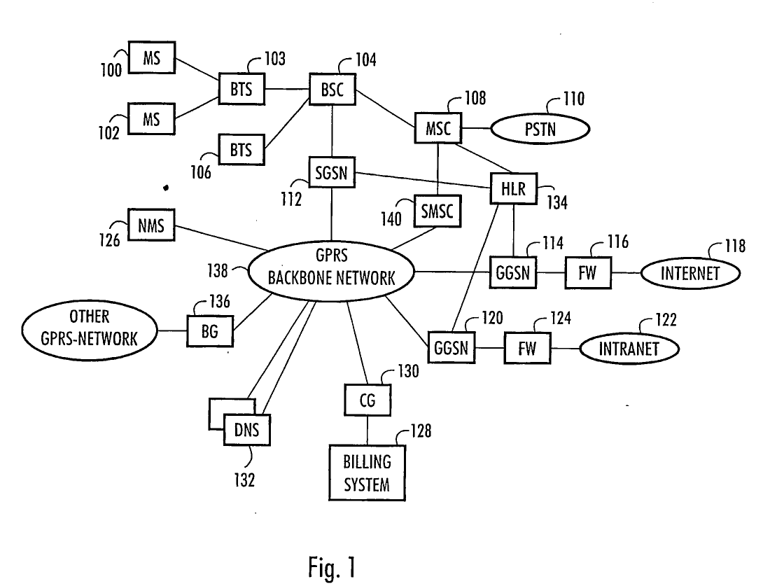

With reference to FIG. 1, examine an example of a data transmission system in which the preferred embodiments of the invention can be applied. FIG. 1 illustrates the structure of a GSM/GPRS (General Packet Radio Service) system. The main elements of the UMTS (Universal Mobile Telecommunications System) are also similar to those of the system disclosed herein. A GRPS terminal device 100-102 communicates with a Base Transceiver Station (BTS) 103, which in turn communicates with a Base Station Controller (BSC) 104. The base station controller is typically connected to a plural number of base stations 103, 106. The base station controller 104 and the base stations 103, 106 form a Base Station Subsystem (BSS) 160.

The base station controller 104 controls the base station 103, 106. The general aim is that the devices that implement the radio path, together with the functionalities associated with them, is located at the base station 103, 106, and the control devices at the base station controller 104.

The base station controller 104 is responsible for example for the management of the radio resources of the base station 103, 106; inter-cell handover operations; frequency management, i.e. the allocation of frequencies to base stations 103, 106; management of frequency hopping sequences; measurement of uplink time delays; implementing an operation and maintenance interface; and management of power control.

The base station 103, 106 comprises at least one transceiver that provides one carrier, i.e. eight time slots or eight physical channels. One base station typically serves one cell, although a solution where one base station serves multiple, sectored cells is also conceivable. The diameter of a cell may vary from a few metres to dozens of kilometres. A part that is also considered to belong to the base station is the transcoder, which carries out the required conversion between the speech-coding format used in the radio system and the one used in the public telephone network. In practice, however, the transcoder is usually physically located at a mobile services switching centre 108 (to be described below). The base station 103, 106 is responsible for example for carrying out timing advance (TA) computation, uplink measurements, channel coding, encryption, decryption and frequency hopping.

In circuit-switched connections, the base station controller 104 is connected to the Mobile Services Switching Centre (MSC) 108, which is the centre of the circuit-switched side. The mobile services switching centre 108 is responsible for example for providing circuit-switched connections to the public switched telephone network PSTN 110; paging; location registration of a user device; handover management; collecting subscriber billing information; data encryption parameter management; frequency allocation management; and echo cancellation.

In packet-switched connections there is a connection from the base station controller to a Serving GPRS Support Node (SGSN) 112, which is the centre of the packet-switched side. The main function of the serving node 112 is to transmit packets to and receive them from a user terminal device 100, 102 supporting packet-switched transmission. The serving node 112 comprises subscriber and location information relating to user devices 100, 102. The serving node is also responsible for identification.

The GPRS network also comprises a Gateway GPRS Support Node (GGSN) 114. The gateway node 114 is responsible for routing outgoing traffic, possibly through a firewall, from the backbone network to external networks, such as the Internet 118. The network may comprise a plural number of gateway nodes, for example a second gateway node 120 as shown in the example of the FIG. to provide access to an Intranet 122 through a firewall 124.

The system preferably comprises further units responsible for different system maintenance functions. The system typically comprises a Network Management System (NMS) 126 responsible for network management and control. A billing system 128 carries out billing and it communicates with the network over a Billing Gateway (BG) 130. The system further comprises Domain Name Servers (DNS) that maintain lists of the IP addresses in the network and the names associated with them.

A Home Location Register (HLR) 134 comprises a permanent subscriber register, which includes for example the following information: an International Mobile Subscriber Identity (IMSI), Mobile Subscriber ISDN Number (MSISDN), and Authentication Key. The home location register also knows other GPRS parameters, such as Quality of Service (QoS), the allowed access point names of each terminal device, IP address type (dynamic or static), whether GPRS roaming and short messages are allowed through the GPRS network. The serving node SGSN 112 uses these data in Context opening.

A Border Gateway (BG) 136 allows the GPRS networks of different operators to communicate with each other.

The system also comprises a Short Message Service Centre (SMSC) 140, which transmits short messages between the network and the terminal devices.

The GPRS backbone network 138 is typically implemented as a network based on the Internet protocol (IP) for transmitting data between different GPRS network elements.

From the point of view of the GPRS system, the terminal device 100, 102 may be in any one of three modes known as idle, ready and standby. In the idle mode the terminal device 100, 102 is not registered into the network and the network does not know the SGSN area where the terminal device is located. Nevertheless, the terminal device may be within the reach of the GSM or UMTS and therefore short messages can be sent and calls set up to it.

If the terminal device 100, 102 wishes to use GPRS services, it carries out a procedure known as a GPRS attach in which a logical connection is set up between the serving node SGSN 112 and the device. This connection is used for authenticating the terminal device, enabling connection ciphering, allocating a temporary identity (TLLI) and copying the user profile from the home location register HLR 134 to the SGSN 112. The network now knows the location of the terminal device with an accuracy of the serving node SGSN. However, no data are transmitted between the terminal device 100, 102 and the node yet, except GPRS control messages. After having completed the GPRS attach, the terminal device is in the ready mode. If the device does not transmit or receive packets for a predetermined period of time, it goes into the standby mode.

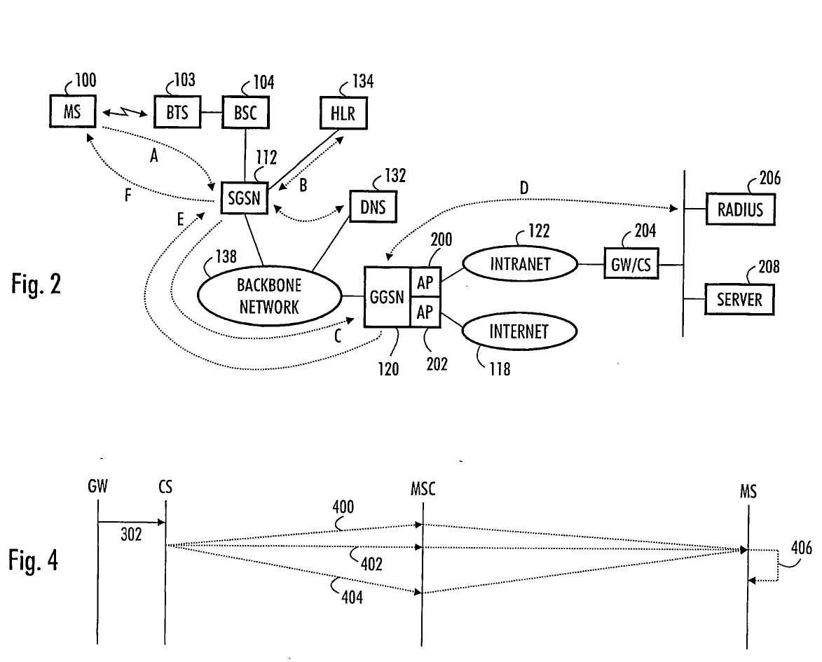

For the terminal device to be able to transmit and/or receive data through the GPRS network, it must first activate the Packet Data Protocol Context (PDPC) that it wishes to use. FIG. 2 illustrates the formation of the PDPC by the terminal device 100. The example assumes that the terminal device 100 wishes to communicate with a server 208, such as a mail server, residing in a company intranet 122.

In step A the terminal device 100 sends the serving node SGSN 112 an Activate PDP Context Request through the base station 103 and the base station controller 104. The activation request typically comprises information about the required Access Point Name (APN) 200. Access Point refers to a particular interface of the gateway node GGSN providing a connection to a desired external network. The gateway node GGSN typically comprises various access points 200, 202 providing connections to different networks, such as company intranets 122, or, through different operators, to the Internet 118. The activation request typically further comprises information about the PDP type, such as the IP, i.e. the Internet protocol, about the desired quality of service, such as transmission rate, and about the IP address, if one is known. The terminal device may have a fixed IP address or one may be determined dynamically for each connection separately.

In step B the serving node SGSN 112 first checks the profile at the home location register HLR 134 to find out whether the desired access point name is allowed, searches the domain name server DNS 134 for the IP address of the gateway node GGSN 120, and maps the APN to the IP address in question.

In step C the serving node SGSN 112 sends a Create PDP Context Request to the gateway node GGSN 120. The request comprises information about the PDP type (such as IP), PDP address, if one is known, the APN, and other parameters, such as information about the desired quality of the connection.

Next, in step D, the GGSN of our example uses the Intranet 122 to contact a RADIUS server 206 of the network in question. The RADIUS (Remote Authentication for Dial-In User Service) server authenticates the terminal device, i.e. checks whether it has access rights to the Intranet and, if a dynamic IP address is to be used, provides the IP address. The IP address may also be retrieved from the internal IP address pool of the gateway node GGSN. A dynamic IP address can also be generated using a DHCP (Dynamic Host Configuration Protocol) server, either within the GGSN or, via the Intranet, within the company in question.

In step E the gateway node GGSN 120 may send a status message to the RADIUS server 206 to inform that the context has been accepted and a Create PDP Context Response to the serving node SGSN 112, which in turn sends an Activate PDP Context Accept to the terminal device 100 in step F. The SGSN can now transmit data between the terminal device 100 and the GGSN 120. The terminal devices may have a plural number of packet data connections open simultaneously.

In the above example illustrating the setting up of a data transmission connection in the GPRS network, connection set up was initiated by the terminal device. When the terminal device has an open packet data connection, it therefore also has the IP address relating to the connection. This allows servers covered by the same connection to transmit data to the terminal device and to receive data from it. If there is no packet connection open, the servers are not able to contact the terminal device.

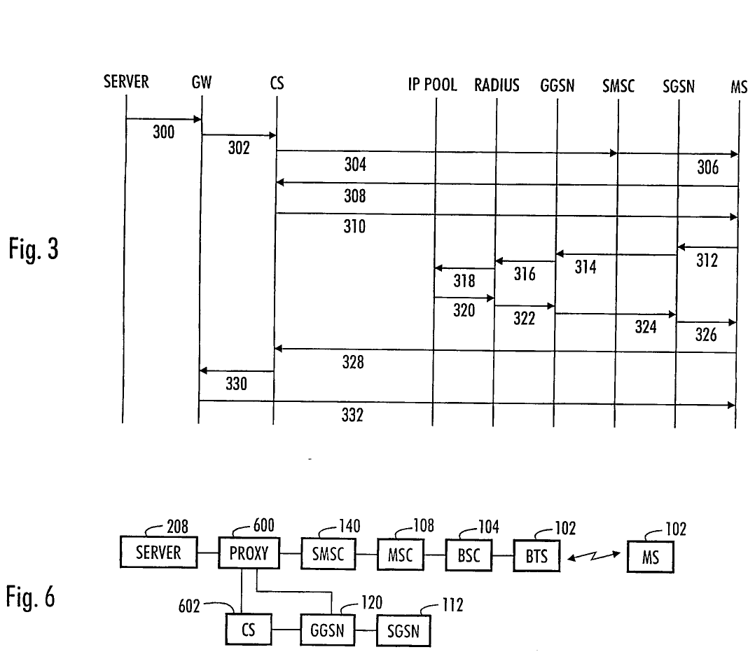

The preferred embodiments of the invention provide the network with the possibility to make an initiative for data transmission between a terminal device and a server residing in the network, for example. Next, let us examine a procedure according to a preferred embodiment of the invention with reference to a signal diagram shown in FIG. 3. This example assumes that a server 208 of a company network 122 wishes to exchange data with a terminal device 102. The terminal device 102 is identified in the network in a known manner (by an MSISDN, for example), but in this example there is no PDC connection created for the terminal device.

The server thus sends data 300 addressed to the terminal device 102. A gateway 204 in the company network receives the data and sends an inquiry 302 to a Context Server (CS), which maintains data indicating which terminal device currently has an active data connection to the company network, i.e. has a PDC created. The context server is typically integrated into the gateway, as in this example, although it may be a separate server in the company network as well. In this case the context server detects that the terminal device has not an activated PDP Context. The context server therefore sends the terminal device a stimulus message 304. In our example the stimulus message 304 is implemented using the short message service and the message from the context server thus proceeds to a short message centre SMSC 140, which transmits the short message 306 to the terminal device 102. A similar mechanism for providing the stimulus message is to use an Unstructured Supplementary Service Data (USSD) service, in which case the short message centre SMC is replaced by a USSD centre. Other alternatives for producing the stimulus message, such as data calls, will be described below.

The terminal device 102 receives the stimulus message and identifies it as such. The identification may be based on the sender of the message or on its contents, for example. When a short message is used, the message may comprise for example a predetermined text identifier determining the PDP Context that is to be activated, or the terminal device may conclude it on the basis of the sender of the message. The text identifier does not need to be in plaintext format. For reasons of data security, a preferred embodiment is implemented using a stimulus message that does not contain any data identifying the gateway, such as a data phone number or an access point name used by the terminal device to communicate with the gateway.

In another preferred embodiment the terminal device at this point sends the context server an authentication message 308 in order to confirm the authenticity of the stimulus message. The terminal device may be configured to accept stimulus messages from specific senders only. After having received a reply 310 from the context server, the terminal device 102 initiates the PDP Context activation. This takes place substantially in the same way as the activation disclosed with reference to FIG. 2.

If the terminal device has not carried out the GPRS attach, this step is completed before the PDP Context activation. We shall assume that the attach has already been performed. Next, the terminal device 102 thus sends an activation request 312 to the operating node SSGN 112. The operating node sends a request 314 for context creation to the gateway node GGSN 120. The gateway node contacts the RADIUS server 206, which authenticates the user and provides the connection with the IP address, after it has inquired 318, 320 about it from the IP address pool residing at the server.

The RADIUS server sends information 322 about the IP address to the gateway node GGSN 120. After having received the IP address from the RADIUS server, the GGSN checks in turn its authenticity from the Access Point specification and optionally sends the RADIUS server status information indicating the IP acceptance (this step is not shown in FIG. 3). Further, the GGSN sends a reply 324 to the serving node SSGN 112, which in turn sends a PDP acceptance message 326 to the terminal device 102.

As the terminal device has thus succeeded in activating the PDP Context according to the stimulus message, it sends some data 328 to the context server. The terminal device does not necessarily have any real data to send, in which case it sends some other data. The context server thus detects that the terminal device 102 has an active data connection created, and it informs 330 the address of the terminal device 102 to the gateway 204. The gateway transmits 332 the data from the server to the terminal device. The server 208 and the terminal device 102 can now transmit data on the connection thus created.

In preferred embodiments of the invention the connection set-up process is carried out by the gateway, without the server being aware of it. It is therefore not necessary for servers of a company network to know the current status of the connections of different terminal devices.

With reference to the signal diagram in FIG. 4, examine then other alternatives for producing the stimulus message. The context server receives the inquiry 302 from the gateway. In some preferred embodiments of the invention the context server may send the stimulus message to the terminal device either as a data call 400, normal speech call 402 or fax call 404. The stimulus message is transmitted through the mobile services switching centre MSC 108 to the terminal device 102. The terminal device is thereby informed of an incoming call and the telephone number of the calling apparatus. The terminal device is configured to know that calls from this number are stimulus messages and that no response is required.

The terminal device 102 does not answer the incoming call but starts a timer 406 to measure the duration of the call alert. This provides the means to inform the terminal device how the connection is to be set up. When the system wants the terminal device to set up a GPRS connection of the type described above, the call alert continues for a predetermined time, for example 3 sec. When the terminal device is to set up a data call, the call alert continues for a different predetermined time, such as 9 sec.

Another method to activate different connections is to indicate the connection type with the type of the stimulus call. A fax call, for example, would require a GPRS connection to be activated, whereas a speech call would mean that a data call is to be activated.

A further method for activating different connections is one in which the terminal is arranged to open a predetermined connection in response to an arriving stimulus call not associated with any time measurement.

A method for transmitting the stimulus message is to send a paging message, for example, on a network control channel to the terminal device.

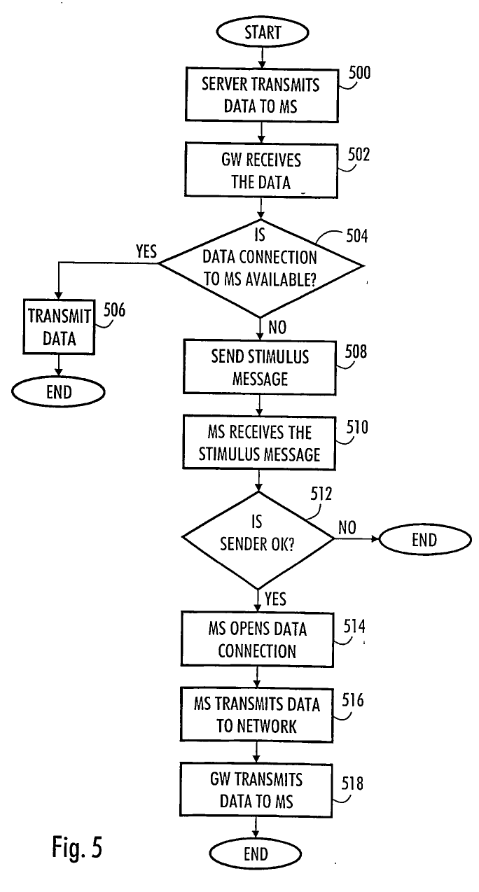

Examine then method steps of a preferred embodiment of the invention with reference to the flow diagram of FIG. 5. In step 500 data addressed to the terminal device is sent from the server to the gateway. The gateway receives the data in step 502. In step 504 the routine checks at the context server whether the terminal device in question has an active data connection to the network. If it is, the data is sent to the terminal device is step 506. If there is no active data connection, a stimulus message is sent to the terminal device in step 508. The terminal device receives the stimulus message in step 510 and authenticates the sender of the stimulus message in step 512. If the authentication shows that the sender is not among the accepted senders, the procedure stops. If the sender is an accepted one, the routing proceeds to step 514 where the terminal device requests the network to open a data connection, and the network opens the desired data connection, such as a GPRS connection or data call. In step 516 the terminal device sends data to the context server, to make sure that the context server detects that the data connection has been set up, and transmits information about the connection to the gateway. In step 518 the gateway starts data transmission to the terminal device.

FIG. 6 illustrates a preferred embodiment of the invention. The server 208 transmits data addressed to the terminal device 102 to a Proxy 600 of the network, which may be an HTTP Proxy or SOCKS Proxy, for example. Proxies are servers used in IP networks for contacting the actual destination of a first party on behalf of the first party. Proxies are used for security reasons (as firewalls) and also to reduce the amount of traffic relayed in the network (as a cache memory) to speed up the operation of the network. The proxies may also comprise an integrated domain name server (DNS). In this embodiment the proxy 600 checks a context server 602 for the IP address of the desired terminal device. A found IP address indicates that the terminal device has an active data connection, and data transmission can be carried out immediately. If no IP address is found, the context server 602 returns the MSISDN number of the terminal device 102 to the proxy 600.

The proxy 600 uses the MSISDM number to send a stimulus message to the terminal device 102. The stimulus message can be sent as a short message, as described above. The message is relayed to the short message centre 140, which forwards it through the mobile services switching centre 102, the base station controller 104 and the base station 103 to the terminal device 102. After an authentication of the stimulus message, if any, the terminal device requests the network to set up a data connection from the serving node 112 and the gateway node 120. When the connection has been set up, the terminal device transmits data informing the context server 602 that the connection has been set up, the context server relaying the information further to the proxy 600. In response to this, the proxy 600 sends data to the terminal device 102.

The context server 602 may also be a separate server communicating with the GGSN server 120 or directly with the backbone network and other servers of the network. In a preferred embodiment, the context server 602 is a matched RADIUS server capable of receiving inquiries using either the IP address of an apparatus that has a data connection or the MSISDN number of an apparatus that does not have a data connection to allow the stimulus to be provided.

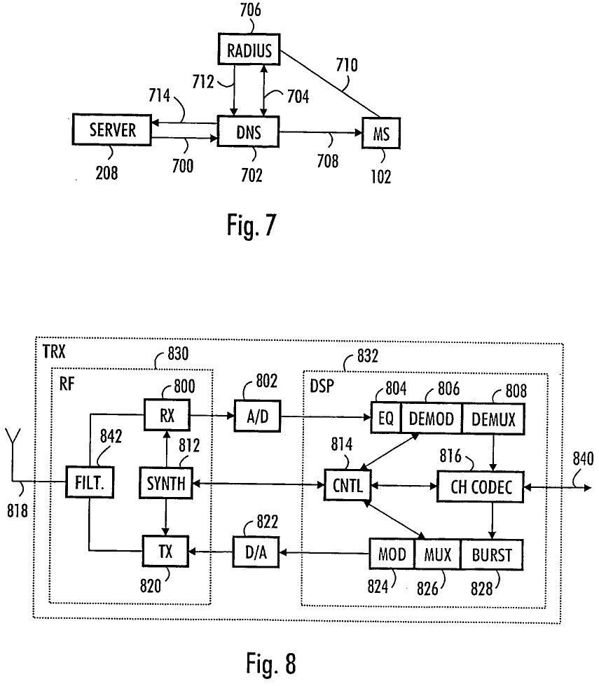

The stimulus functionality can also be implemented in the domain name server (DNS). Let us examine FIG. 7. It is usual in Internet connections that the server 208 contacts 700 the domain name server 702 to inquire the IP address corresponding to the name of a device 102. The domain name server checks the data connection status of the device 102. An IP address found either from the domain name server into which the device 102 is registered or by inquiring 704 from the RADIUS server 706 indicates that the device has an active data connection and data transmission can be carried out immediately by returning the IP address to the server 208. If no IP address is found, the domain name server provides the stimulus 708 on the basis of the MSISDN number stored in its database or to be retrieved from another server. On the basis of the stimulus message, the device 102 sets up 710 the data connection through the RADIUS server. From the RADIUS server the domain name server receives information 712 indicating that the data connection has been opened. After having detected that the data connection has been set up, the domain name server returns the IP address 714 to the server 208. The domain name server can also be implemented to comprise an integrated RADIUS server.

In the above-described examples the server contacts a terminal device residing in the GPRS network. These are, however, only examples, and the communicating devices may naturally be of some other type as well. Alternatives where both the devices are terminal devices or computers connected to the network through terminals are also conceivable.

FIG. 8 illustrates the structure of a device in a wireless system in which the solution of the preferred embodiments of the invention can be applied. The device comprises an antenna 818 used for sending and receiving signals. From the antenna a signal is supplied to a duplex filter, which separates signals of the transmitting direction from those of the receiving direction. A receiver 800 comprises a filter blocking frequencies outside the desired frequency band. Next, the signal is converted into an intermediate frequency or directly into a baseband, the converted signal being then sampled and quantized in an analog-to-digital converter 802. An equalizer 804 compensates for damage caused by multi-path propagation, for example. From the equalized signal, a demodulator 806 separates a bit stream, which is supplied to a demultiplexer 808. The demultiplexer 808 separates the bit stream from the different time slots into their logical channels. A channel codec 816 decodes the bit streams of the different logical channels, i.e. decides whether a bit stream is signalling data, which is to be supplied to a control unit 814, or whether it is speech, which is to be supplied 840 further to a speech codec, for example. The channel codec 816 also carries out error correction. The control unit 814 performs internal control functions by controlling different units. A burst former 828 adds a training sequence and a tail to the data arriving from the channel codec 816. The multiplexer 826 assigns each burst its time slot. A modulator 824 modulates digital signals to a radio-frequency carrier. This is an analog operation and therefore an analog-to-digital converter 822 is needed to execute it. A transmitter 820 comprises a filter to restrict the bandwidth. In addition, the transmitter 820 controls the output power of the transmission. A synthetizer 812 provides the different units with the frequencies they need. The synthetizer 812 comprises a clock, which may be locally controlled. The synthetizer 812 creates the necessary frequencies by means of a voltage-controlled oscillator, for example.

As shown in FIG. 8, the structure of the transceiver can be further divided into radio frequency parts 830 and a digital signal processor with its software 830. The radio frequency parts 830 comprise the receiver 800, transmitter 820 and synthesizer 812. The digital signal processor and its software 832 comprise the equalizer 804, demodulator 806, demultiplexer 808, channel codec 816, control unit 814, burst former 828, multiplexer 826, and modulator 824. The analog-to-digital converter is needed 802 for converting an analog radio signal into a digital one, and, correspondingly, the digital-to-analog converter 822 is needed for converting a digital signal into an analog one.

The device may further comprise user interface parts, such as a display, keyboard, earpiece and microphone, which are not, however, shown in the FIG. The control unit 814 of the device is typically implemented as a microprocessor or as separate logic circuits comprising memory elements, with the necessary software included.

According to some preferred embodiments of the invention, the terminal device comprises means (830, 832) for detecting and receiving a stimulus message sent to it, and means (830, 832) for initiating the setting up of an active data connection between the device and the rest of the system on the basis of the stimulus message, as described above.

The device according to the preferred embodiments can also be a combination of the above-described terminal device and a portable computer communicating with it.

The disclosed functionalities of the preferred embodiments of the invention can be advantageously implemented by means of software in the terminal device and the different parts of the data transmission system.

Although the invention is described above with reference to an example according to the accompanying drawings, it is obvious that the invention is not restricted to it but may be varied in many ways within the inventive idea disclosed in the accompanying claims.

1. A data transmission method between a first device and a second device, which is at the end of a wireless network connection and does not have an active data transmission connection to a network, in which method data addressed to the second device is transmitted from the first device to the network, the method comprising:
detecting in the network that the second device does not have an active data transmission connection;
sending a stimulus message from the network to the second device;
receiving the stimulus message at the second device;
setting up a data connection between the network and the second device on the basis of the stimulus message; and
transmitting to the second device the data addressed to it.

2. A method according to claim 1, wherein the stimulus message sent to the second device is a short message.

3. A method according to claim 1, wherein the stimulus message sent to the second device is a data call.

4. A method according to claim 1, wherein the stimulus message sent to the second device is a fax call.

5. A method according to claim 1, wherein the stimulus message sent to the second device is an ordinary call.

6. A method according to claim 1 wherein the stimulus message is a message that is to be sent to the terminal device on a control channel.

7. A method according to claim 1, wherein the stimulus message sent to the second device is a USSD (Unstructured Supplementary Service Data) message.

8. A method according to claim 1, wherein the second device authenticates the sender of the stimulus message.

9. A method according to claim 1, wherein the second device accepts stimulus messages only from predetermined senders.

10. A method according to claim 1, wherein the wireless network is based on a General Packet Radio Service (GPRS) system.

11. A method according to claim 1, wherein the wireless network is based on a Universal Mobile Telecommunications System (UMTS) system.

12. A method according to claim 1, wherein the wireless network is based on a Global System for Mobile communications (GSM) system.

13. A method according to claim 1, wherein:
the gateway receives from the first device data addressed to the second device;
the gateway sends a context server an inquiry about the connection of the second device;
the context server detects that the second device does not have an active data connection to the network;
the context server sends the second device a stimulus message;
the second device requests the network to set up a data connection;
the context server receives information about the connection set-up;
the context server informs the gateway about the connection; and
the gateway sends data to the second device.

14. A method according to claim 13, wherein the existence of the second device is confirmed by data transmission from the second device to the context server.

15. A method according to claim 1, further comprising a proxy receiving from the first device data addressed to the second device, wherein:
the proxy sends the context server an inquiry about the IP address of the second device;
the context server detects that the second device does not have an IP address and returns the MSISDN number of the device to the proxy;
the proxy sends the second device a stimulus message on the basis of its MSISDN number;
the second device requests the network to set up a data connection;
the context server receives information about the connection set-up;
the context server informs the proxy about the connection; and
the proxy sends data to the second device.

16. A method according to claim 1, wherein the type of the connection to be opened is indicated to the second device in the stimulus message.

17. A method according to claim 3, wherein the terminal device identifies calls coming from a specific number as stimulus messages.

18. A method according to claim 3, wherein the terminal device identifies the type of the connection to be opened on the basis of the duration of the call alert.

19. A method according to claim 1, wherein the type of connection used to deliver the stimulus message is different from the connection type the terminal device is requested to open.

20. A data transmission system comprising devices which are at the end of a wireless connection and does not have a continuous, active data transmission connection to a network, and a first device which is arranged to transmit data to a second device, which is at the end of the wireless connection, the system comprising:
means for detecting that the second device does not have an active data connection at the moment the system has data addressed to the second device;
means for sending a stimulus message to the device; and
wherein the second device comprises means for detecting a received stimulus message and for starting the setting up of a data connection between the device and the rest of the system on the basis of the stimulus message.

21. A system according to claim 20, wherein the second device is arranged to authenticate the sender of the stimulus message.

22. A system according to claim 20, wherein the second device is arranged to accept stimulus messages only from predetermined senders.

23. A system according to claim 20, wherein the wireless network is based on a General Packet Radio Service (GPRS) system.

24. A system according to claim 20, wherein the wireless network is based on a GMS system.

25. A system according to claim 20, wherein the wireless network is based on a Universal Mobile Telecommunications System (UMTS) system.

26. A system according to claim 20, further comprising a gateway and a context server, the gateway being arranged to receive data addressed to the second device and to send the context server an inquiry about the connection of the second device; and wherein
the context server is arranged to send the second device a stimulus message when it detects that the second device does not have an active data connection to the network.

27. A system according to claim 20, further comprising a proxy and a context server, the proxy being arranged to
receive data addressed to the second device;
send the context server an inquiry about the IP address of the second device;
receive the MSISDN number of the second device from the context server; and
send the second device a stimulus message on the basis of its MSISDN number.

28. A system according to claim 20, further comprising a domain name server and a context server, the domain name server being arranged to
reply to address inquiries relating to the second device;
re-send an inquiry relating to the IP address of the second device to the context server;
receive from the context server the MSISDN number of the second device; and to
send the second device a stimulus message on the basis of its MSISDN number.

29. A system according to claim 20, further comprising a domain name server and a context server, the domain name server being arranged to
reply to address inquiries relating to the second device;
detect that the second device does not have a data connection; and to
send the second device a stimulus message on the basis of the MSISDN number stored in the data of the domain name server.

30. A system according to claim 26, wherein the context server is a RADIUS server arranged to reply to IP address inquiries by supplying the address or MSISDN number of an active data connection.

31. A terminal device in data transmission system, which terminal device is at the end of a wireless connection and does not have a continuous, active data connection to a network, the terminal device comprising:
means for detecting and receiving a stimulus message sent to it; and
means for initiating the setting up of an active data connection between the device and the rest of the system on the basis of the stimulus message.

32. A terminal device according to claim 31, wherein the terminal device is arranged to authenticate the sender of the stimulus message.

33. A terminal device according to claim 31, wherein the terminal device is arranged to accept stimulus messages only from predetermined senders.

34. A terminal device according to claim 31, wherein the terminal device is arranged to identify calls coming from a specific number as stimulus messages.

35. A terminal device according to claim 31, wherein the terminal device is arranged to identify the type of the connection to be opened on the basis of the duration of the call alert.

36. A method according to claim 4, wherein the terminal device identifies calls coming from a specific number as stimulus messages.

37. A method according to claim 5, wherein the terminal device identifies calls coming from a specific number as stimulus messages.

38. A method according to claim 4, wherein the terminal device identifies the type of the connection to be opened on the basis of the duration of the call alert.

39. A method according to claim 5, wherein the terminal device identifies the type of the connection to be opened on the basis of the duration of the call alert.

40. A system according to claim 27, wherein the context server is a RADFUS server arranged to reply to IP address inquiries by supplying the address or MSISDN number of an active data connection.

41. A system according to claim 28, wherein the context server is a RADIUS server arranged to reply to IP address inquiries by supplying the address or MSISDN number of an active data connection.

42. A system according to claim 29, wherein the context server is a RADIUS server arranged to reply to IP address inquiries by supplying the address or MSISDN number of an active data connection.
